(19) United States
(12) Patent Application Publication
(10) Pub. No.: US 2026/0162160 A1
(43) Pub. Date: Jun. 11, 2026

(54) DYNAMIC PRICING RELATED TO A PRODUCT PLAN

(71) Applicant: KYOCERA Document Solutions Inc., Osaka (JP)

(72) Inventor: David James Thomas, Las Vegas, NV (US)

(21) Appl. No.: 18/970,774

(22) Filed: Dec. 5, 2024

(51) Int. Cl. G06Q 30/0601

(52) U.S. Cl. CPC G06Q 30/0611

(57) ABSTRACT

Systems and methods relate generally to dynamic pricing for a product plan. In a method, available features associated with one or more models of equipment for document processing are automatically determined by a cloud-based application in networked communication with the equipment. A user interface is displayed on a display screen to obtain selection information of the available features of the equipment. A price quote is tailored-generated by the cloud-based application using the selection information for the product plan and automatically for the one or more models of the equipment. The price quote is sent as an electronic message.

### FIELD

The following description relates to dynamic pricing. More particularly, the following description relates to dynamic pricing related to a product plan.

### BACKGROUND

Generally, many software sales are moving toward providing Internet accessible services with cloud-based applications rather than licensing product software. Along those lines, “Anything-as-a-Service” or “Everything-as-a-Service” (“XaaS”) has emerged, which can include Al services. These XaaS offerings may be apportioned out with selected services to provide a product plan customized to specific needs of each client with corresponding pricing.

However, for features for a device located on customer premises, this can be more difficult. In particular, providing XaaS offerings for a printing device or a multifunction printing device located at a customer's site can be problematic.

### SUMMARY

In accordance with one or more below described examples, a method relating generally to dynamic pricing for a product plan is disclosed. In such a method, available features associated with one or more models of equipment for document processing are automatically determined by a cloud-based application in networked communication with the equipment. A user interface is displayed on a display screen to obtain selection information of the available features of the equipment. A price quote is tailored-generated by the cloud-based application using the selection information for the product plan and automatically for the one or more models of the equipment. The price quote is sent as an electronic message.

In accordance with one or more below described examples, a system relating generally to dynamic pricing for a product plan is disclosed. In such a system, there is equipment for document processing with each having: a memory configured to store program code; and a processor coupled to the memory. A cloud-based application of a cloud computing system is in networked communication with the equipment. In combination and response to executing the program code, the equipment and the cloud-based application in combination is configured to facilitate performance of operations. Along those lines, available features associated with one or more models of the equipment for document processing are automatically determined by the cloud-based application in networked communication with the equipment. A user interface is displayed on a display screen to obtain selection information of the available features of the equipment. A price quote is tailored-generated by the cloud-based application using the selection information for the product plan and automatically for the one or more models of the equipment. The price quote is sent as an electronic message.

In accordance with one or more below described examples, a machine-readable storage medium relating generally to dynamic pricing for a product plan is disclosed. In such a machine-readable storage medium, executable instructions that, when executed by a processor, facilitate performance of operations, including: automatically determining available features associated with one or more models of on-premises equipment for document processing by a cloud-based application in networked communication with the on-premises equipment; displaying on a display screen a user interface to obtain selection information of the available features of the on-premises equipment; tailored-generating of a price quote by the cloud-based application using the selection information for the product plan and automatically for the one or more models of the on-premises equipment; and sending the price quote as an electronic message.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIGS. 1-1 through 1-3 are respective flow diagrams depicting respective examples of a sales pricing flow.

FIG. 2 is a flow diagram depicting an example of a sales-pricing flow.

FIG. 3 is a block-pictorial diagram depicting an example of a networked system.

FIG. 4 is a pictorial diagram depicting an example of a network.

FIG. 5 is a block diagram depicting an example of a portable communication device.

FIG. 6 is a block diagram depicting an example of a multi-function printer (MFP).

FIG. 7 is a block diagram depicting an example of a computer system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

In a conventional document sales environment, products are discussed and priced based on features and functionality for an end user or customer. Generally, features and functionality (hereinafter collectively and singly “features”) are bundled in packages, which are pre-determined based on what sellers anticipate their customers want. Since packages are determined before sale of products, it makes it difficult to scale to a variety of target audiences based on their solution needs.

As described below in additional detail, a goal is to let each customer choose what features it needs for their on-premises customer equipment for their business, and then dynamically price a model of a product on a feature-by-feature basis after selection of such features. Along those lines, rather than pre-packaging features, a more tailored approach to paying only for what a customer needs may be used. On-premises customer equipment in this example is one or more models of “document processing devices”. These “document processing devices” may be multi-function printers, dedicated printers, dedicated scanners, copiers, or the like. As there may be different models, where some models may not have every possible feature available, building custom feature-by-feature product plans tailored to each end user's on-premises customer equipment may be useful for existing customers. Additionally, a customer may purchase a product with less than all of the features in an available feature set, and yet have an ability to expand into other available features, such as for a growing business for example, without having to make an upfront purchase of a full feature set.

With the above general understanding borne in mind, various configurations for systems, and methods therefor, for dynamic pricing on a feature-by-feature basis are generally described.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc., may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

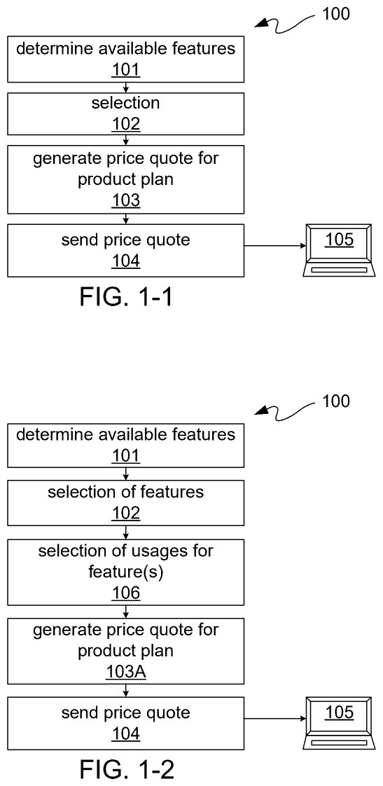

FIG. 1-1 is a block-flow diagram depicting an example of a sales-pricing (“sales”) flow 100. At 101, available features associated with one or more models for one or more possible solutions may be determined.

For new purchases online, one or more possible solutions may be represented at least in part as lists or tables of all available features of all possible equipment options available, where such equipment may represent one or more different sets of such features on a model-by-model basis. Such one or more possible solutions may be represented via a user interface on a display.

Available features associated with one or more models of on-premises salesroom equipment for document processing may be automatically determined by a cloud-based application in networked communication with such on-premises salesroom equipment. This may be used to enhance an informed buying experience for a hands on sales experience.

For an installed base, available features associated with one or more models of on-premises customer equipment for document processing may be automatically determined by a cloud-based application in networked communication with such on-premises customer equipment. For a hybrid of an installed base and salesroom equipment, available features associated with one or more models of on-premises customer equipment and on-premises salesroom equipment for document processing may be automatically determined by a cloud-based application in networked communication with such on-premises customer equipment and on-premises salesroom equipment.

Any one or more of the above examples may be combined to determine available features associated with one or more models for one or more possible solutions. However, for purposes of clarity by way of example and not limitation, on-premises equipment is described below.

At 102, displaying on a display screen a user interface for selection of one or more features available for such on-premises equipment. At 102, selection information may be obtained from available features of on-premises equipment. A user or customer may select features feature-by-feature to suit their business or other needs.

After a user selects all features that they want to presently purchase or license for their company, at 103 a price quote may be generated by a cloud-based application using such selection information to provide a product plan. In addition to tailoring such a price quote to selected features, such price quote may be automatically generated to the one or more models of on-premises equipment to have a product plan with one or more upgrade paths. If a business plans on expanding, it may be useful to know in advance equipment purchased may be upgraded to include one or more features to be incorporated as part of such expansion.

To recap, a product price may be generated based on the selection of features. This helps gives a unique experience to an end user that is tailored and generated specifically for each customer. Furthermore, a customer need not have to pay for features they do not need and instead may only pay for solutions based on their particular needs. This might help with scalability to existing customers and potential new customers as customer obtained features for document solutions continues to grow.

At 104, such a price quote may be displayed on a display screen, such as of a computer 105, or otherwise sent as an electronic message to computer 105 or another electronic device, such as an email, a text, a push notice, or other form.

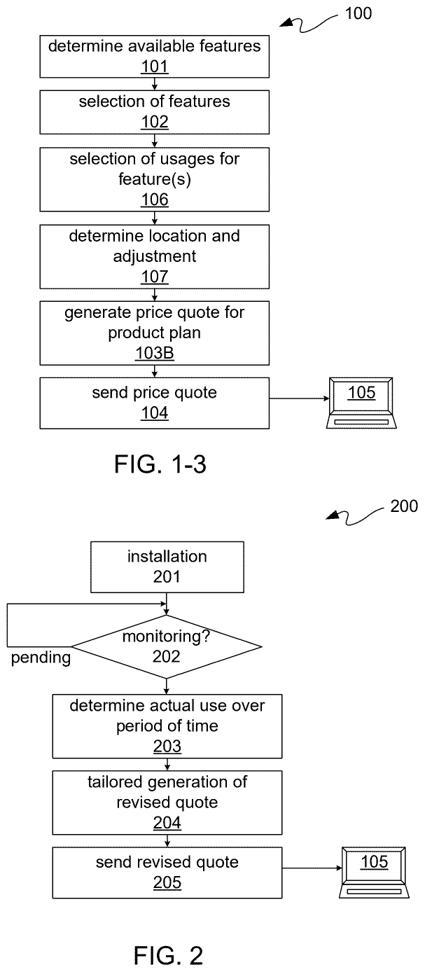

FIG. 1-2 is a block-flow diagram depicting another example of a sales flow 100. At 101, available features associated with one or more models for one or more possible solutions may be determined, as previously described. Again, for purposes of clarity by way of example and not limitation, an example of on-premises equipment quote generation is described.

At 102, displaying on a display screen a user interface for selection of one or more features available for such on-premises equipment, such as previously described. For each applicable feature selected at 102, at 106 selection information may be obtained for usage or usage rate for each applicable one of such features selected for on-premises equipment. At 106, a user interface may be displayed on a display screen to obtain selection information of customer anticipated usage or usage rate of one or more of applicable available features selected at 102 for such on-premises equipment.

After a user selects all features and corresponding usages, as applicable, that they want to presently purchase or license for their company, at 103A a price quote may be generated by a cloud-based application using such feature and usage selection information to provide a product plan. In addition to tailoring such a price quote to selected features and applicable corresponding usages, such price quote may be automatically generated to the one or more models of on-premises equipment to have a product plan with one or more upgrade paths. These upgrade paths may be for example include additional features and corresponding usages, as well as possibly increased usages for previously customer obtained features.

To recap, a product price may be generated based on the selection of features and corresponding usages. So, first selection information may be customer-selected features available for on-premises equipment, and second selection information may be customer-selected anticipated usage rates of the one or more of of such customer selected features for such on-premises equipment. This helps gives a unique experience to an end user that is tailored and generated specifically for each customer. Furthermore, a customer need not have to pay for excessive usages they do not need of selected features they do need and instead may only pay for solutions based on their particular feature and corresponding usage needs.

At 104, such a price quote may be provided to a customer, as previously described.

FIG. 1-3 is a block-flow diagram depicting yet another example of a sales flow 100. At 101, available features associated with one or more models for one or more possible solutions may be determined, as previously described. Again, for purposes of clarity by way of example and not limitation, an example of on-premises equipment quote generation is described.

At 102, displaying on a display screen a user interface for selection of one or more features available for such on-premises equipment, such as previously described. At 106, selection information may be obtained for usage or usage rate for each applicable one of such features selected for on-premises equipment, as previously described.

At 107, location of on-premises equipment may be determined. This determination may be by customer input delivery address for new orders, but for existing orders this may be automatically performed using a customer's network address, such as Internet Protocol (“IP”) address information. Along those lines, a customer may have moved on-premises equipment to a new location different from an original delivery location.

Further at 107, based on location an adjustment value may be obtained. For example, costs in a location may be more or less expensive than another location. An adjustment value obtained at 107 may be a cost of living adjustment associated with location of on-premises equipment.

At 103B, a price quote may be generated by a cloud-based application using such feature and usage selection information, as well as an adjustment value for such location information, to provide a product plan. At 104, such a price quote may be provided to a customer, as previously described.

FIG. 2 is a block-flow diagram depicting an example of a sales flow 200. After an installation of on-premises equipment at 201, monitoring of such on-premises equipment may begin at 202. Such monitoring may be for features used, usage rates of such features, demand for features at particular times of day, days of a week, times of a year, and so on. A cloud-based application may perform this monitoring. This monitoring may occur for an interval or other period of time. If a period of time has not been reached, sales flow 200 may stay pending until such period of time has been reached.

After a period of time has been reached for monitoring at 202, at 203 a cloud-based application may determine for each customer actual features used and corresponding actual usage rates for on-premises equipment over such a period of time at a location. A period of time may for example be a week-to-week, month-to-month, quarter-to-quarter, semi-annual-to-semi-annual, year-to-year, or other period of time. Again, data usage may vary depending on time of day, day of the week, seasonal, and so on. An example of seasonal usage may be tax season. However, other examples may apply as may vary from business-to-business.

At 204, a revised price quote (“revised quote”), such as of a previously generated price quote at 103 or a previously generated revised quote at 204, may be a tailored generation by a cloud-based application using a customer's actual features used and corresponding actual usage rates, as well as adjusted for a current location and cost of living in such location, for on-premises equipment over a period of time. Along those lines, on-premises equipment may have been moved to a different location from an original installation location, and so a revised quote automatically take this into account.

At 205, such a revised quote may be displayed on a display screen, such as of a computer 105, or otherwise sent as a message to computer 105 or another electronic device, such as an email, a text, a push notice, or other form.

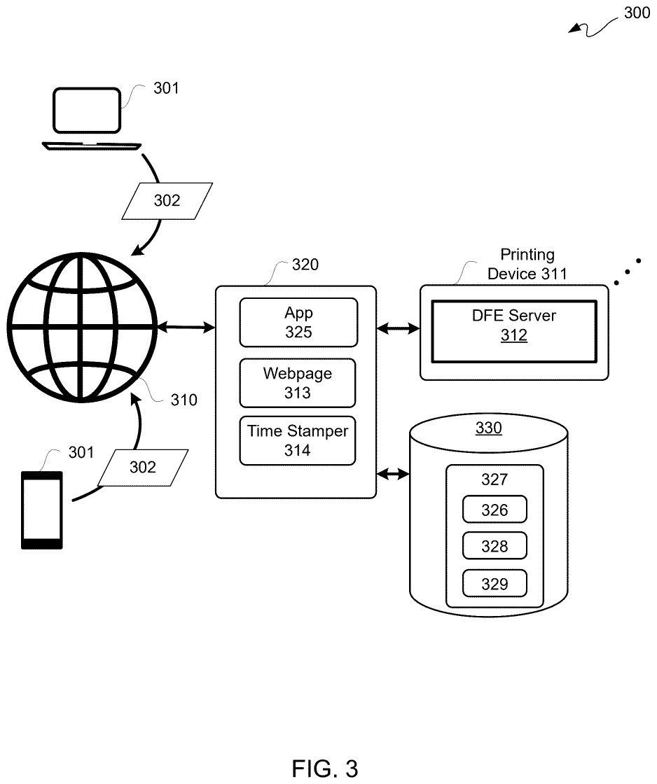

FIG. 3 is a block-flow diagram depicting an example of a networked system 300. User devices 301, such as smart phones, tablets, notebook computers, desktop computers, among other electronic devices capable of sending a job to a printing device via a network, may provide print jobs 302 to a network, such as the Internet 310 or another network.

A network appliance 320 may be in communication with the Internet 310 and a printing device 311.

A printing device 311, which in this example is a multi-function printer having printing, scanning and copying functions among others for document processing, may be in communication with user devices 301 via the Internet 310 and a network appliance 320.

Even though a single printing device 311 is described, multiple printing devices of one or more models may form on-premises equipment, as previously described. In this example, printing device 311 includes a digital front end or DFE server 312. DFE 312 is an appliance designed to drive a print engine of a printer system. A DFE may accept a print file, such as for example a portable document format (PDF) or PostScript file, and interpret that file to convert it into a format that a print engine (such as for example a toner or inkjet print engine) can use to “lay down” content on a substrate, such as paper for example. A DFE 312 may include a print engine, such as including a Raster Image Processor (RIP), and may provide additional functionality depending on printer system. Sites using AFP, Xerox Metacode, XSL-FO files, HP-PCL files or similar formats have generally the same workflow as using PostScript or PDF, and so a PDF workflow is described for purposes of clarity by way of example and not limitation. Generally, a printer engine interprets an inbound file, conventionally one page at a time, and renders a continuous tone bitmap based on directions of such file. Conventionally, a printer engine creates a screened file ready for use. Different printer system vendors may have their own sets of algorithms designed to tune screening to their print engine, so files sent to different machines may render differently.

In a workflow, a DFE 312 may manage color, ICC profiles, imposition, and handle variable data. DFEs on production inkjet devices may include options for setting ink levels and managing options for drying levels and print speeds. Some production devices may offer more than one approved DFE, having different features and functions sets, supported file formats, print speeds, automation levels, and communications between workflows for example, from which a user can select for their workflow.

Network appliance 320 may include a cloud-based application 325. Cloud-based application 325 may be as configured as previously described with reference to FIGS. 1-1 through 2. Cloud-based application (“app”) 325 may be associated with a webpage 313 of network appliance 320 in this example for providing a user interface or UX, as previously described with reference to FIGS. 1-1 through 2.

App 325 may be in communication with printing device 311, including DFE 312, to determine available features and functions of such printing device. Examples of possible available features include document converting, document splitting, and artificial intelligence processing. Such available features may further include page scaling, page autorotating, automatic blank page removing, electronic signing, and file merging. Document converting may use optical character recognition (OCR), or other form of recognition such as word recognition for example, to convert a scanned document into a file.

Network appliance 320 may include a time stamper 314 for time stamping incoming jobs 302 for purposes of monitoring usage of features over a period of time, as previously described. App 325 may monitor usage of features for determining actual usages and of what features over such a period of time. End user use data 326 and on-premises equipment configuration data 328 may be stored in a database 327 in storage 330 in communication with network appliance 320. Along those lines, pricing models 329 for each user, including location information, service area, and cost of living adjustment information as part of end user use data 326, may be stored in database 327. Additionally, tracking information to determine how well pricing models for customers, including customer retention information, may be stored in database 327.

Because one or more of the examples described herein may be implemented using an information processing system, a detailed description of examples of each of a network (such as for a Cloud-based XaaS (Everything-as-a-Service) implementation), a computing system, a mobile device, and an MFP is provided. However, it should be understood that other configurations of one or more of these examples may benefit from the technology described herein.

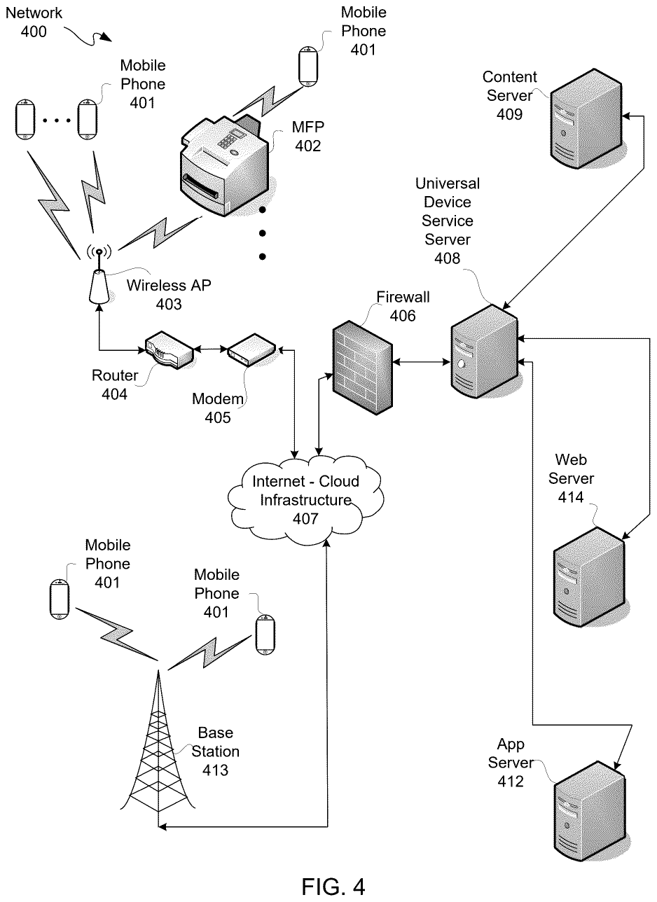

FIG. 4 is a pictorial diagram depicting an example of a network 400, which may be used to provide a SaaS platform for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401 may be in wireless communication with a base station 413.

Additionally, a desktop computer and/or a printing device, such as for example one or more multi-function printer (“MFPs”) 402, each of which may be web-usable devices, may be in wireless and/or wired communication to and from router 404. An MFP 402 may include at least one plasma head as previously described herein.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

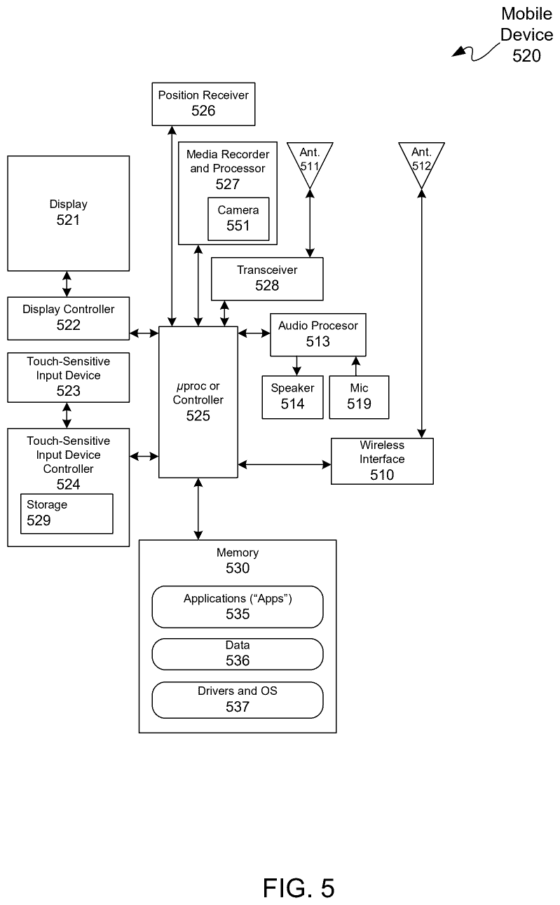

FIG. 5 is a block diagram depicting an example of a portable communication device (“mobile device”) 520. Mobile device 520 may be an example of a mobile device used to instruct a printing device.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps, such as a mobile client application as described hereinabove, may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data. Apps 535 may include an XJDF reference file for a hot folder for communicating to a printer system in place of a printer driver.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera 551, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

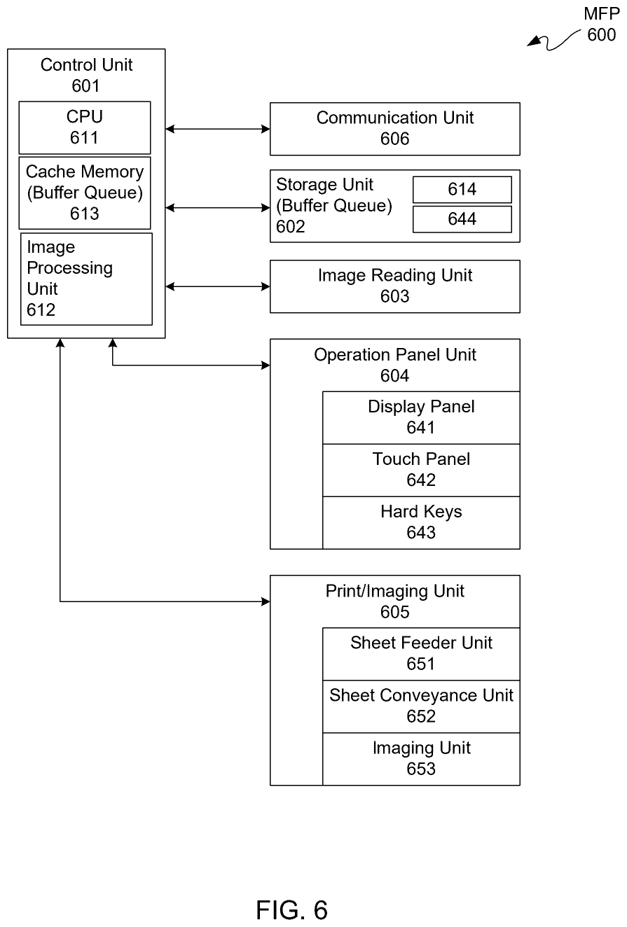

FIG. 6 is a block diagram depicting an example of a multi-function printer MFP 600. MFP 600 is provided for purposes of clarity by way of non-limiting example. MFP 600 is an example of an information processing system such as for handling a printer job.

MFP 600 includes a control unit 601, a storage unit 602, an image reading unit 603, an operation panel unit 604, a print/imaging unit 605, and a communication unit 606. Communication unit 606 may be coupled to a network for communication with other peripherals, mobile devices, computers, servers, and/or other electronic devices. Control unit 601 may include a CPU 611, an image processing unit 612, and cache memory 613.

Control unit 601 may be included with or separate from other components of MFP 600. Storage unit 602 may include ROM, RAM, and large capacity storage memory, such as for example an HDD or an SSD. Storage unit 602 may store various types of data and control programs, including without limitation a printer imaging pipeline program 614 and a printer job settings app 644. A buffer queue may be located in cache memory 613 or storage unit 602.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

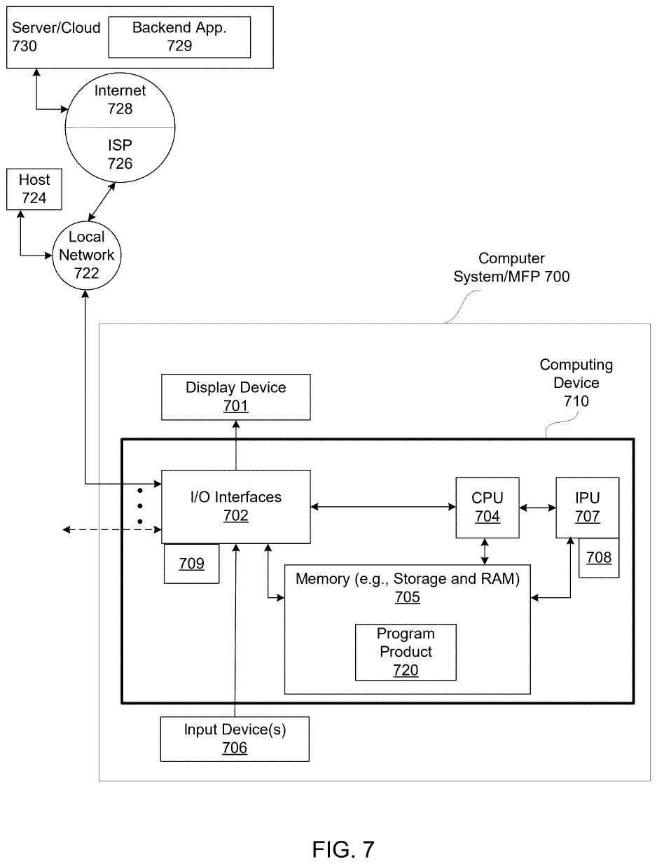

FIG. 7 is a block diagram depicting an example of a computer system or MFP 700 (“computer system”) upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 by itself or networked with one or more other computer systems 700 may provide an information handling/processing system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCIe bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide a program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer- or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application for providing one or more applications or services as described herein. Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

What is claimed is:

1. A method for dynamic pricing for a product plan, comprising:
automatically determining available features associated with one or more models of equipment for document processing by a cloud-based application in networked communication with the equipment;
displaying on a display screen a user interface to obtain selection information of the available features of the equipment;
tailored-generating of a price quote by the cloud-based application using the selection information for the product plan and automatically for the one or more models of the equipment; and
sending the price quote as an electronic message.

2. The method according to claim 1, wherein the selection information is first selection information, and the equipment is on-premises equipment, the method further comprising:
displaying on the display screen the user interface to obtain second selection information of anticipated usage rate of one or more of the available features selected in the first selection information for the on-premises equipment; and
tailored-generating of the price quote by the cloud-based application using the first selection information and the second selected information for the product plan for the on-premises equipment.

3. The method according to claim 2, further comprising:
determining location of the on-premises equipment;
adjusting the price quote by a cost of living adjustment associated with the location; and
sending the price quote as adjusted as the electronic message.

4. The method according to claim 3, wherein the first selection information is customer-selected features available for the on-premises equipment, and the second selection information is customer-selected anticipated usage rates of the one or more of the customer selected features for the on-premises equipment, the method further comprising:
determining by the cloud-based application actual features used and corresponding actual usage rates for the on-premises equipment over a period of time;
tailored-generating of a revised quote of the price quote by the cloud-based application using the actual features used and the actual usage rates for the on-premises equipment over the period of time; and
sending the revised quote as another electronic message.

5. The method according to claim 4, wherein the available features for the document processing are associated with at least one of printing and scanning.

6. The method according to claim 5, wherein the available features include document converting, document splitting, and artificial intelligence processing.

7. The method according to claim 6, wherein the available features further include page scaling, page autorotating, automatic blank page removing, electronic signing, and file merging.

8. The method according to claim 7, wherein the document converting uses optical character recognition to convert a scanned document into a file.

9. The method according to claim 8, wherein the tailored-generating of the revised quote comprises seasonally adjusting the price quote to provide the revised quote.

10. The method according to claim 9, wherein the on-premises equipment includes a multi-function printer.

11. A system, comprising:
equipment for document processing with each having:
a memory configured to store program code; and
a processor coupled to the memory;
a cloud-based application of a cloud computing system in networked communication with the equipment;
wherein, in combination and response to executing the program code, the equipment and the cloud-based application in combination is configured to facilitate performance of operations, comprising:
automatically determining available features associated with one or more models of the equipment for document processing by the cloud-based application in networked communication with the equipment;
displaying on a display screen a user interface to obtain selection information of the available features of the equipment;
tailored-generating of a price quote by the cloud-based application using the selection information for the product plan and automatically for the one or more models of the equipment; and
sending the price quote as an electronic message.

12. The system according to claim 11, wherein the selection information is first selection information, the equipment is on-premises equipment, and wherein the operations further comprise:
displaying on the display screen the user interface to obtain second selection information of anticipated usage rate of one or more of the available features selected in the first selection information for the on-premises equipment; and
tailored-generating of the price quote by the cloud-based application using the first selection information and the second selected information for the product plan for the on-premises equipment.

13. The system according to claim 12, wherein the first selection information is customer-selected features available for the on-premises equipment, the second selection information is customer-selected anticipated usage rates of the one or more of the customer selected features for the on-premises equipment, and wherein the operations further comprise:
determining by the cloud-based application actual features used and corresponding actual usage rates for the on-premises equipment over a period of time;
tailored-generating of a revised quote of the price quote by the cloud-based application using the actual features used and the actual usage rates for the on-premises equipment over the period of time; and
sending the revised quote as another electronic message.

14. The system according to claim 13, wherein the operations further comprise:
determining location of the on-premises equipment;
adjusting the revised quote by a cost of living adjustment associated with the location; and
sending the other message as the revised quote as adjusted for the location.

15. The system according to claim 14, wherein the available features for the document processing are associated with at least one of printing and scanning by the on-premises equipment as a multi-function printer.

16. A machine-readable storage medium, comprising executable instructions that, when executed by a processor, facilitate performance of operations, comprising:
automatically determining available features associated with one or more models of on-premises equipment for document processing by a cloud-based application in networked communication with the on-premises equipment;
displaying on a display screen a user interface to obtain selection information of the available features of the on-premises equipment;
tailored-generating of a price quote by the cloud-based application using the selection information for the product plan and automatically for the one or more models of the on-premises equipment; and
sending the price quote as an electronic message.

17. The machine-readable storage medium according to claim 16, wherein the selection information is first selection information, and wherein the operations further comprise:
displaying on the display screen the user interface to obtain second selection information of anticipated usage rate of one or more of the available features selected in the first selection information for the on-premises equipment; and
tailored-generating of the price quote by the cloud-based application using the first selection information and the second selected information for the product plan for the on-premises equipment.

18. The machine-readable storage medium according to claim 17, wherein the first selection information is customer-selected features available for the on-premises equipment, the second selection information is customer-selected anticipated usage rates of the one or more of the customer selected features for the on-premises equipment, and wherein the operations further comprise:
determining by the cloud-based application actual features used and corresponding actual usage rates for the on-premises equipment over a period of time;
tailored-generating a revised quote of the price quote by the cloud-based application using the actual features used and the actual usage rates for the on-premises equipment over the period of time; and
sending the revised quote as another electronic message.

19. The machine-readable storage medium according to claim 18, wherein the operations further comprise:
determining location of the on-premises equipment;
adjusting the revised quote by a cost of living adjustment associated with the location; and
sending the revised quote as adjusted for the location as the other electronic message.

20. The machine-readable storage medium according to claim 19, wherein the available features for the document processing are associated with at least one of printing and scanning by the on-premises equipment including a multi-function printer.
